(19) United States
(12) Patent Application Publication
(10) Pub. No.: US 2026/0042485 A1
(43) Pub. Date: Feb. 12, 2026

(54) INTEGRALLY REINFORCED SILL STRUCTURE FOR A VEHICLE, AND VEHICLE

(71) Applicant: AUDI AG, lngolstadt (DE)

(72) Inventors: Tobias URBAN, Besigheim (DE); Jochen RÖCKER, Affalterbach (DE)

(73) Assignee: AUDI AG, lngolstadt (DE)

(21) Appl. No.: 19/257,620

(22) Filed: Jul. 2, 2025

(30) Foreign Application Priority Data
Aug. 7, 2024 (DE) 102024122511.4

(51) Int. Cl. B62D 21/15; B62D 25/02; B62D 27/02; B62D 29/00

(52) U.S. Cl. CPC B62D 21/157; B62D 25/025; B62D 27/023; B62D 29/00

(57) ABSTRACT

A sill structure for a vehicle, including a hollow body, which extends in an x-direction of the vehicle as intended and is made of a first steel sheet shell and a second steel sheet shell, and a U-shaped reinforcing element arranged in the hollow body and extending continuously in the x-direction over a length of the hollow body, which reinforcing element is connected to an inner surface of the first steel sheet shell, as well as to a vehicle comprising a sill structure.

### FIELD

The invention relates to a sill structure for a vehicle, comprising a hollow body, which extends in an x-direction of the vehicle as intended and which is made of a first steel sheet shell and a second steel sheet shell, and a U-shaped reinforcing element arranged in the hollow body and extending continuously in the x-direction over a length of the hollow body, which reinforcing element is connected to an inner surface of the first steel sheet shell. Furthermore, the invention relates to a vehicle with a sill structure.

### BACKGROUND

Sill structures of the type mentioned above are known in the prior art in various designs and serve to ensure the structural stability of a vehicle's passenger cell and to protect the vehicle against a lateral collision. In an electric vehicle, the sill structures particularly protect the high-voltage (HV) traction battery of the electric vehicle, which is usually located in a floor region of the vehicle between the two sill structures.

WO 2019/059821 A1 discloses a sill structure for a vehicle, which comprises a hollow body consisting of two shells and extending as intended in an x-direction of the vehicle, and a wave-shaped reinforcing element arranged in the hollow body, which is arranged in a region of a B-pillar of the vehicle with respect to an x-direction of the vehicle and is in contact with each shell of the hollow body.

DE 10 2015 207 376 A1 discloses a sill structure for a vehicle, which is made of a fiber-reinforced plastic and comprises a hollow body consisting of two shells, which extends in an x-direction of the vehicle as intended, and a reinforcing element arranged in the hollow body and which is connected to each shell in a planar manner.

### SUMMARY

It is an object of the invention to provide an alternative sill structure for a vehicle which is cost-effective to manufacture and easy to assemble and which meets future requirements regarding forces to be absorbed. Another object of the invention is to provide a vehicle with a sill structure.

The invention relates to a sill structure for a vehicle, comprising a hollow body, which extends in an x-direction of the vehicle as intended and is made of a first steel sheet shell and a second steel sheet shell, and a U-shaped reinforcing element arranged in the hollow body and extending continuously in the x-direction over a length of the hollow body, which reinforcing element is connected to an inner surface of the first steel sheet shell. The hollow body has a structure that is as simple as possible. It consists of the two steel sheet shells, i.e. a cross-sectional surface of the steel sheet shells extending perpendicular to the x-direction is topologically a circular ring. In other words, the two sheet steel shells completely enclose a cavity within the hollow body. The hollow body has an elongated shape and defines a longitudinal direction of the hollow body which extends at least substantially parallel to the x-direction.

Due to the connection of the U-shaped reinforcing element with the first steel sheet shell, an empty path between the reinforcing element and the first steel sheet shell is avoided, i.e. force transmission occurs without delay in the event of an impact.

The reinforcing element enables the sill structure to absorb greater forces than the hollow body on its own. With respect to a y-direction of the vehicle, the two steel sheet shells can be referred to as an inner shell and an outer shell, with the first steel sheet shell being either the inner shell or the outer shell.

The U-shape of the reinforcing element means that a cross-section of the reinforcing element perpendicular to the x-direction is U-shaped. Due to the U-shape, the reinforcing element is open on one side. Together with the connected first steel sheet shell, the U-shaped reinforcing element forms a completely enclosed cavity within the cavity formed by the two steel sheet shells.

According to the invention, the reinforcing element is arranged at a distance from an inner surface of the second sheet steel shell. The second sheet steel shell is accordingly either the outer shell or the inner shell, i.e. the remaining shell. The distance between the reinforcing element and the second steel sheet shell means that the reinforcing element is not connected to the second steel sheet shell, which simplifies assembly of the sill structure.

The smaller the distance between the reinforcing element and the second sheet steel shell, the shorter the free travel corresponding to the distance.

The reinforcing element may have two flange sections extending continuously in the x-direction over a length of the reinforcing element, which flange sections are in contact with the inner surface of the first sheet steel shell. The two flange sections allow a continuous connection of the reinforcing element to the first steel sheet shell, which results in a stable connection between the first steel sheet shell and the reinforcing element.

In one embodiment, the reinforcing element is formed in one piece. In the case of the one-piece design, the sill structure consists of only three parts, which gives the sill structure a great structural simplicity.

In an alternative embodiment, the reinforcing element comprises two separate parts extending continuously in the x-direction and overlapping portions of the two parts are in contact with each other. In this case, the sill structure consists of four parts and is structurally somewhat more complex than the three-part version. However, this is offset by greater flexibility in the design of the reinforcing element.

Advantageously, the two parts of the reinforcing element have different wall thicknesses and/or the two parts of the reinforcing element comprise different materials. The two parts of the reinforcing element can, for example, differ in wall thickness, i.e. one part can be stronger than the other. The materials of the two parts can also differ. Adequately selected wall thicknesses and/or materials can optimize the ability of the reinforcing element to absorb or dissipate forces or reduce the costs of the sill structure.

The reinforcing element may comprise a deep-drawn part and/or be designed as a tailored blank and/or comprise a high-strength steel or consist of a high-strength steel and/or be at least partially tempered. Deep drawing of a sheet metal blank is an inexpensive and proven method for forming the reinforcing element. A tailor-made blank is, for example, designed as a Tailor Welded Blank, TWB, a Tailor Rolled Blank, TRB, or a Patchwork Blank.

Examples of high-strength steels include dual-phase (DP) steels, complex-phase (CP) steels, TRIP steels, retained austenite (RA) steels, or martensite (MS) steels. A tempered steel or quenched and tempered steel is a steel that achieves high tensile and fatigue strength as a result of tempering, i.e. quenching and tempering.

Furthermore, the reinforcing element can have a bulge in a front end region with respect to the x-direction and/or a width of the reinforcing element measured with respect to a y-direction of the vehicle can vary in the x-direction. The bulge is an expansion of a cross-sectional area of the cavity formed by the reinforcing element together with the first sheet steel shell.

Preferably, the reinforcing element comprises a plurality of stiffening elements arranged one behind the other with respect to the x-direction, and/or the reinforcing element comprises a plurality of local doublers and/or a plurality of local bulkheads. The stiffening elements may include corrugations, beads, embossments, local bulges and the like.

Each sheet steel shell may have two flange sections extending continuously in the x-direction of the vehicle, with corresponding flange sections being in contact with one another. The two sheet steel shells can be easily connected using the flange sections. The two flange sections of each sheet steel shell protrude from edges of the respective sheet steel shell that extend in the x-direction as intended and, in particular, extend in at least substantially opposite directions.

The flange sections of the sheet steel shells advantageously extend parallel to an xz-plane of the vehicle. In particular, the flange sections may extend in the same plane.

Ideally, sections and/or surfaces of the sill structure are connected in an alternating manner respectively by means of a plurality of welding points. The welding points are created, for example, by means of resistance welding, which is cost-effective, does not require additional parts and can be implemented within a production line with short cycle times. In addition, all sections and/or surfaces to be welded are accessible from two sides, which allows for easy production of the sill structure.

Another subject of the invention is a vehicle comprising two sill structures arranged on opposite lateral outer sides of the vehicle. The sill structures are usually arranged in a floor region of the vehicle and can in particular protect a high-voltage traction battery of an electric vehicle arranged between the sill structures.

According to the invention, each sill structure is designed according to an embodiment of the invention. Thanks to the sill structure according to the invention, vehicle safety is improved, especially in the event of a side collision.

A significant advantage of the sill structure according to the invention is that it is inexpensive to manufacture, easy to assemble and meets future requirements regarding forces to be absorbed.

### BRIEF DESCRIPTION OF THE FIGURES

The invention is schematically illustrated in the drawings with the aid of an embodiment and is described further with reference to the drawings. In the figures:

FIG. 1 shows a side view of a sill structure according to an embodiment of the invention for a vehicle;

FIG. 2 shows a cross-sectional view of the sill structure shown in FIG. 1;

FIG. 3 shows a perspective side view of the sill structure shown in FIG. 1.

### DETAILED DESCRIPTION

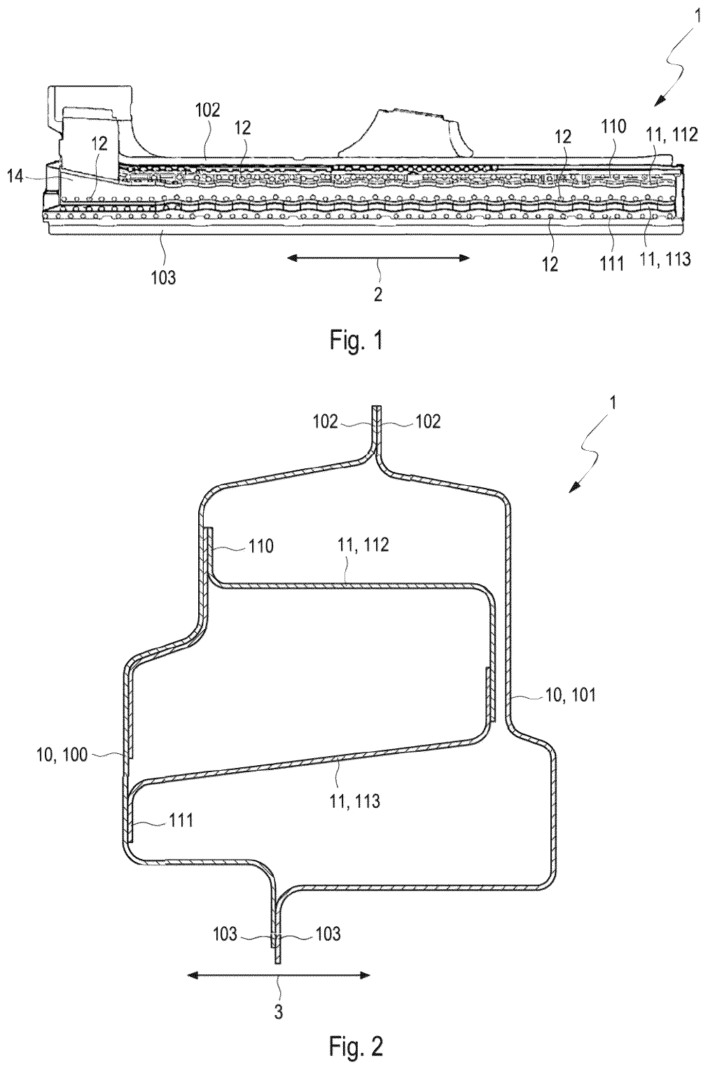

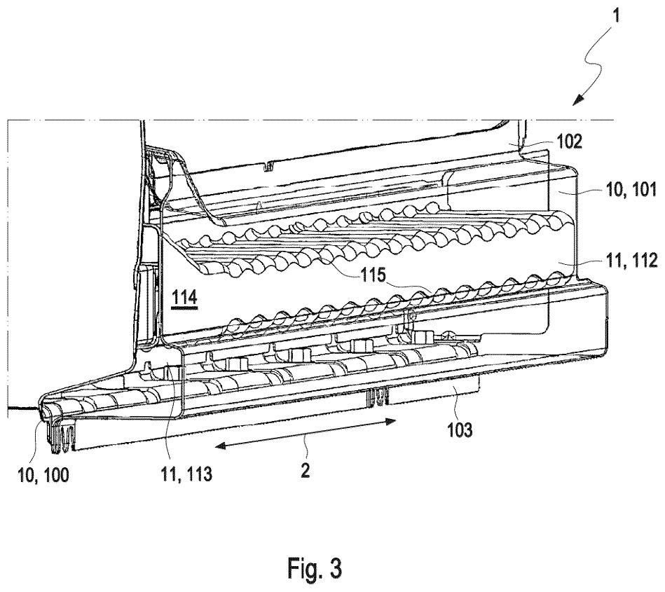

FIG. 1 shows a side view of a sill structure 1 according to an embodiment of the invention for a vehicle. FIG. 2 shows a cross-sectional view of the sill structure 1 shown in FIG. 1. FIG. 3 shows a perspective side view of the sill structure 1 shown in FIG. 1.

A vehicle according to an embodiment of the invention may comprise two sill structures 1 arranged on opposite lateral outer sides of the vehicle.

The sill structure 1 comprises a hollow body 10 extending as intended in an x-direction 2 of the vehicle, consisting of a first sheet steel shell 100 and a second sheet steel shell 101, which is omitted in FIG. 1. Each sheet steel shell 100, 101 may have two flange sections 102, 103 extending continuously in the x-direction 2 of the vehicle, with corresponding flange sections 102, 103 being in contact with one another. The flange sections 102, 103 of the sheet steel shells 100, 101 advantageously extend parallel to an xz-plane of the vehicle.

Furthermore, the sill structure 1 comprises a U-shaped reinforcing element 11 arranged in the hollow body 10, which reinforcing element extends continuously over a length of the hollow body 10 in the x-direction 2.

The reinforcing element 11 is connected to an inner surface of the first steel sheet shell 100.

The reinforcing element 11 may have two flange sections 110, 111 extending continuously in the x-direction 2 over a length of the reinforcing element 11, which flange sections are in contact with the inner surface of the first sheet steel shell 100.

The reinforcing element 11 is arranged at a distance from an inner surface of the second sheet steel shell 101.

The reinforcing element 11 preferably comprises two separate parts 112, 113 extending continuously in the x-direction 2. Overlapping sections of the two parts 112, 113 are in contact with each other. Then the two parts 112, 113 of the reinforcing element 11 can have different wall thicknesses and/or comprise different materials. Alternatively, the reinforcing element 11 can be formed in one piece.

The reinforcing element 11 may comprise a deep-drawn part and/or be designed as a tailor-made blank, tailored blank. Furthermore, the reinforcing element 11 may comprise a high-strength steel or consist of a high-strength steel and/or be at least partially tempered.

For example, the reinforcing element 11 has a bulge 114 in a front end region relative to the x-direction 2. Apart from that, a width of the reinforcing element 11 measured in relation to the y-direction 3 of the vehicle can vary in the x-direction 2.

In addition, the reinforcing element 11 can have a plurality of stiffening elements 115 which are arranged one behind the other with respect to the x-direction 2. Alternatively or additionally, the reinforcing element may comprise a plurality of local doublers and/or a plurality of local bulkheads.

Sections and/or surfaces of the sill structure 1, which are in contact with each other, can respectively be materially connected by means of a plurality of welding points 12.

### LIST OF REFERENCE NUMERALS

1 sill structure
10 hollow body
100 first steel sheet shell
101 second sheet steel shell
102 flange section
103 flange section
11 reinforcing element
110 flange section
111 flange section
112 part
113 part
114 bulge
115 stiffening element
12 welding point
2 x-direction
3 y-direction

1. A sill structure for a vehicle, comprising: a hollow body consisting of a first steel sheet shell and a second steel sheet shell, which hollow body extends as intended in an x-direction of the vehicle, and a U-shaped reinforcing element arranged in the hollow body and extending continuously in the x-direction over a length of the hollow body, which reinforcing element is connected to an inner surface of the first steel sheet shell and arranged at a distance from an inner surface of the second steel sheet shell.

2. The sill structure according to claim 1, wherein the reinforcing element has two flange sections extending continuously in the x-direction over a length of the reinforcing element and in contact with the inner surface of the first steel sheet shell.

3. The sill structure according to claim 1, wherein the reinforcing element is formed in one piece.

4. The sill structure according to claim 1, wherein the reinforcing element comprises two separate parts extending continuously in the x-direction and wherein overlapping sections of the two parts are in contact with one another.

5. The sill structure according to claim 4, wherein the two parts of the reinforcing element have different wall thicknesses and/or comprise different materials.

6. The sill structure according to claim 1, wherein the reinforcing element comprises a deep-drawn part and/or is designed as a tailor-made blank, tailored blank, and/or comprises a high-strength steel or consists of a high-strength steel and/or is at least partially tempered.

7. The sill structure according to claim 1, wherein the reinforcing element has a bulge in a front end region relative to the x-direction and/or a width of the reinforcing element measured relative to a y-direction of the vehicle varies in the x-direction.

8. The sill structure according to claim 1, wherein the reinforcing element has a plurality of stiffening elements which are arranged one behind the other with respect to the x-direction, and/or comprises a plurality of local doublers and/or a plurality of local bulkheads.

9. The sill structure according to claim 1, wherein each sheet steel shell (100, 101) has two flange sections extending continuously in the x-direction of the vehicle, wherein corresponding flange sections are in contact with one another.

10. The sill structure according to claim 9, wherein the flange sections (102, 103) of the sheet steel shells extend parallel to an xz plane of the vehicle as intended.

11. The sill structure according to claim 1, wherein sections and/or surfaces of the sill structure are connected in mutual material contact by means of a plurality of welding points.

12. A vehicle comprising two sill structures arranged on opposite lateral outer sides of the vehicle, each according to claim 1.

13. The sill structure according to claim 2, wherein the reinforcing element is formed in one piece.

14. The sill structure according to claim 2, wherein the reinforcing element comprises two separate parts extending continuously in the x-direction and wherein overlapping sections of the two parts are in contact with one another.

15. The sill structure according to claim 2, wherein the reinforcing element comprises a deep-drawn part and/or is designed as a tailor-made blank, tailored blank, and/or comprises a high-strength steel or consists of a high-strength steel and/or is at least partially tempered.

16. The sill structure according to claim 3, wherein the reinforcing element comprises a deep-drawn part and/or is designed as a tailor-made blank, tailored blank, and/or comprises a high-strength steel or consists of a high-strength steel and/or is at least partially tempered.

17. The sill structure according to claim 4, wherein the reinforcing element comprises a deep-drawn part and/or is designed as a tailor-made blank, tailored blank, and/or comprises a high-strength steel or consists of a high-strength steel and/or is at least partially tempered.

18. The sill structure according to claim 5, wherein the reinforcing element comprises a deep-drawn part and/or is designed as a tailor-made blank, tailored blank, and/or comprises a high-strength steel or consists of a high-strength steel and/or is at least partially tempered.

19. The sill structure according to claim 2, wherein the reinforcing element has a bulge in a front end region relative to the x-direction and/or a width of the reinforcing element measured relative to a y-direction of the vehicle varies in the x-direction.

20. The sill structure according to claim 3, wherein the reinforcing element has a bulge in a front end region relative to the x-direction and/or a width of the reinforcing element measured relative to a y-direction of the vehicle varies in the x-direction.
